(19) United States
(12) Patent Application Publication
(10) Pub. No.: US 2013/0140249 A1
(43) Pub. Date: Jun. 6, 2013

(54) FEED DELIVERY SYSTEM FOR A SOLID-LIQUID SEPARATION VESSEL

(71) Applicants: Ken N. Sury, Calgary (CA); Clay Robert Sutton, Redondo Beach, CA (US); John Diep, Edmonton (CA); Darwin Edward Kiel, New Westminster (CA)

(72) Inventors: Ken N. Sury, Calgary (CA); Clay Robert Sutton, Redondo Beach, CA (US); John Diep, Edmonton (CA); Darwin Edward Kiel, New Westminster (CA)

(21) Appl. No.: 13/813,020

(22) PCT Filed: Jun. 17, 2011
(86) PCT No.: PCT/US11/40930

§ 371 Date: Jan. 29, 2013

(30) Foreign Application Priority Data
Aug. 17, 2010 (CA) 2711136

(51) Int. Cl. B01D 21/24

(52) U.S. Cl. CPC B01D 21/2405
USPC 210/800; 210/513

(57) ABSTRACT

A method of delivering feed, for example a paraffinic solvent treated bitumen froth, to a separation vessel, for example a froth separation unit (FSU). The feed is delivered from one or more inlets into the side of a series of parallel plates that form a series of channels which may be either vertical or inclined at an intermediate angle. This feed inlet flow conditioning system is characterized by a Channel Reynolds number of less than 3000. Such inlet flow conditioning is particularly useful where the feed has particles with a bi-modal size distribution to be separated from an overflow stream. The low Reynolds number combined with the influence of the walls serves to mitigate the upward flux of the smaller particles, for example mineral solids, by trapping the smaller particles within a matrix of larger particles, for example precipitated asphaltene aggregates.

### CROSS-REFERENCE TO RELATED APPLICATIONS

This application claims priority from Canadian patent application number 2,711,136 filed on Aug. 17, 2010 entitled Feed Delivery System for a Solid-Liquid Separation Vessel, the entirety of which is incorporated by reference herein.

### FIELD OF THE INVENTION

This invention is in the field of solid-liquid gravity driven separation vessels. More particularly, this invention relates to the feed delivery used in a solid-liquid gravity driven separation vessel.

### BACKGROUND OF THE INVENTION

Many industrial processes require separation of solid particles from a continuous liquid phase. In gravity separators, a slurry stream comprising liquid and solid particles is delivered to a vessel where the solid particles settle by gravity and are removed from the bottom of the vessel, while the clarified liquid is removed from the top of the vessel. In most processes, the solid particles are distributed in size, where the large particles settle more quickly and the small particles settle more slowly. Particles that have settling velocities smaller than the upward flux (superficial velocity) of liquid may not settle at all, but may instead be carried over with the clarified liquid. Optimum separation efficiency is generally achieved in conventional separators by promoting a uniform upward velocity distribution, as this determines the maximum particle size that can be carried over. Increasing the vessel size, for example, decreases the upward velocity and thereby reduces the size of the largest particles that carry-over, thereby increasing the fraction of particles that report to the underflow. The manner in which the feed is delivered to the separation vessel can have a substantial effect on solid-liquid separation efficiency. Conventional feed delivery methods are often designed to distribute feed over a broad cross-section of the vessel, where the objective is to reduce the solids concentration, thereby reducing hindered settling and increasing the terminal velocities of the particles. The two primary objectives of a conventional feed distributor designed for broad particle size distributions are therefore to achieve a uniform upward velocity distribution and to broadly distribute the feed over the entire vessel cross-section. Examples of common feed distribution systems include a vertical pipe passing through the top of the vessel combined with a horizontal deflector plate, a feed-well designed to both decelerate and distribute the slurry, and multi-arm or concentric ring spargers. These types of distributor systems are often ineffective with respect to separating the fine particles. Indeed, these approaches are often counter-productive due to the dilution that occurs as the coarse and fine particles are dispersed over the settler or thickener cross-sectional area. In conventional processes, the dispersion of feed reduces the hindering effect and thereby increases the settling rate of the large particles. These processes also act to reduce the interaction between the coarse and fine particles, increasing the fraction of fine particles that are free to report to the upwardly moving stream.

### SUMMARY OF THE INVENTION

Consistent with an aspect of the instant invention, a very different feed delivery system is required in those applications where it is important to separate a significant fraction of the fine particles having terminal velocities much smaller that the upward superficial velocity. In this case, a specialized feed delivery system is required to enhance the separation of fine particle with low terminal velocities. Rather than distributing the feed over a wide-cross section of the vessel, which simply leads to a high carry-over rate of fine particles, the approach embodied by aspects of the instant invention seeks to increase the separation efficiency of fine particles in a slurry comprising a blend of large particles, having terminal velocities which are much higher than the upward superficial velocity, and small particles, having terminal velocities which are much lower than the upward superficial velocity, for example where the proportion of large particles is typically greater than 90%, and where the solids volume fraction of the particles overall is typically 20% or less. The feed distributor concept described herein is designed to rapidly densify the inflowing slurry stream, entrapping fine particles in the interstitial spaces between the coarser particles, and thereby increasing the likelihood that they will exit with the coarse particles in the underflow stream.

Generally, the present invention provides, in one aspect, a method of delivering feed, for example paraffinic solvent-treated bitumen froth, to a separation vessel, for example a froth separation unit (FSU). The feed is delivered from one or more inlets into the side of a series of parallel plates that form a series of channels of a feed inlet conditioner, where the plates may be either vertical or inclined at an intermediate angle. In contrast to certain conventional feed systems used in gravity separators which use devices such as deflector plates, feed-wells or spargers, to widely distribute the feed across the vessel cross-section, the feed is delivered with relatively low momentum over part of the vessel cross-sectional area. This feed inlet flow conditioning system is characterized by a Channel Reynolds number of less than 3000. Such inlet flow conditioning is particularly useful where the feed has particles with a bi-modal size distribution to be separated from an overflow stream. The low Reynolds number combined with the influence of the walls serves to mitigate the upward flux of the smaller particles, for example mineral solids, by trapping the smaller particles within a matrix of larger particles, for example precipitated asphaltene aggregates.

As described below, data obtained from extensive physical modeling simulations of the actual PFT process show that this type of feed delivery consistently outperforms a conventional distributor having a vertical pipe and deflector design.

In one aspect, there is provided a method of delivering a feed, the feed comprising a liquid component and a solid component into a separation vessel for separating the liquid component from the solid component, the method comprising: delivering the feed into the vessel through one or more inlets in the vessel into sides of a series of plates that form a series of channels of an inlet feed conditioner, wherein the feed is delivered with a channel Reynolds number of less than 3000, to encourage smaller solid particles of the solid component to be incorporated into, or trapped within or under, or entrained down by, larger solid particles of the solid component, or aggregates of the larger solid particles, and to be carried to an underflow.

In certain embodiments, the following features may be present. The parallel plates may occupy less than 20%, or less than 10%, of a cross-sectional area of the vessel. The Channel Reynolds number may be greater than 200. The Channel Reynolds number may be less than 1000. The Channel Reynolds number may be greater than 200 and less than 500. The plates may be inclined from vertical by an angle of 5 to 85 degrees, or inclined from vertical by an angle of 20 to 50 degrees, or inclined from vertical by an angle of 25 to 45 degrees, or inclined from vertical by an angle of 30 to 40 degrees, or within 5 degrees of vertical, or vertical. The plates may have a length to gap ratio of at least 15. The plates may be parallel within an angle of 10% with one another. The parallel plates may be separated from one another by between 100 mm and 200 mm. The separation vessel may be a gravity separation vessel. The feed may be a solvent-treated bitumen froth. The solvent may be a paraffinic solvent. The solid component may have a bi-modal size distribution. The solid component may comprise precipitated asphaltene aggregates and mineral solids. The feed may be delivered at a rate sufficient to generate a superficial vessel flux of 200 mm/min to 700 mm/min. The feed may be delivered using four inlets. The one or more inlets may be side inlets in a side wall of the vessel. More than 50 mass % of the mineral solids may have a terminal velocity less than an upward superficial velocity of the liquid component in the vessel. The plates may be flat. The plates may be corrugated. The plates may be disposed with a plate spacing that narrows from a top of the inlet feed conditioner to a bottom of the inlet flow conditioner. The plates may be disposed with a plate spacing that is more narrow at a bottom of the inlet feed conditioner than at a top of the inlet flow conditioner.

In one aspect, there is provided a feed inlet conditioner system for use with a froth separation unit for feeding and conditioning solvent-treated bitumen froth comprising bitumen, water, precipitated asphaltene aggregates, and mineral solids, the system comprising: a feed inlet conditioner comprising a series of parallel plates forming a series of channels therebetween for encouraging the mineral solids of a solid component of the froth to be incorporated into, or trapped within or under, or entrained down by the precipitated asphaltene aggregates of the solid component and to be carried out to an underflow; and at least one inlet for delivering the feed to sides of the parallel plates. In one embodiment, the side-inlet Richardson number is equal to or greater than 2.0 but not more than 13.2.

### BRIEF DESCRIPTION OF THE DRAWINGS

Embodiments of the present invention will now be described, by way of example only, with reference to the attached Figures, wherein:

FIG. 1 is a flow diagram of a bitumen froth treatment process;

FIG. 2A is a schematic of a feed delivery arrangement using a deflector plate;

FIG. 2B is a schematic of a feed delivery arrangement using a feed well and a deflector plate, showing both top and side configurations;

FIG. 2C is a schematic of a feed delivery arrangement using a multi-arm sparger configuration;

FIG. 3 is a schematic of an inlet feed conditioner in a separation vessel in accordance with a disclosed embodiment;

FIG. 4 is a schematic of an inlet feed conditioner in a separation vessel in accordance with a disclosed embodiment;

FIG. 5 is a schematic of an inlet feed conditioner in a separation vessel in accordance with a disclosed embodiment;

FIG. 6 is a schematic of an inlet feed conditioner in a separation vessel in accordance with a disclosed embodiment;

FIG. 7 is a schematic of an inlet feed conditioner in a separation vessel in accordance with a disclosed embodiment;

FIG. 8 is a schematic of an inlet feed conditioner in a separation vessel in accordance with a disclosed embodiment;

FIG. 9 is a schematic of an inlet feed conditioner in a separation vessel in accordance with a disclosed embodiment;

FIG. 10 is a schematic of an inlet feed conditioner in a separation vessel in accordance with a disclosed embodiment;

FIG. 11 is a schematic of a cross-over phenomenon in parallel plates;

FIG. 12 is a schematic of corrugated plates in accordance with a disclosed embodiment;

FIG. 13A is a schematic of narrowing plates in accordance with a disclosed embodiment;

FIG. 13B is a schematic of plates with a slip in accordance with a disclosed embodiment;

FIG. 14A is perspective view of an experimental apparatus used to test feed delivery;

FIG. 14B is a top view of the apparatus of FIG. 14A;

FIG. 14C is a side view of the apparatus of FIG. 14A;

FIG. 14D is a front view of the apparatus of FIG. 14A;

FIG. 15 is a plot of normalized grade carry-over curves described herein;

FIG. 16 is a plot of normalized grade carry-over curves described herein;

FIG. 17 is a schematic of an experimental arrangement described herein;

FIG. 18 is a plot of normalized grade carry-over curves described herein;

FIG. 19 is a schematic showing an alternative feed delivery using plenums;

FIG. 20 is a plot of normalized grade carry-over curves described herein; and

FIG. 21 is a plot of normalized grade carry-over curves described herein.

### DESCRIPTION OF PREFERRED EMBODIMENTS

Myriad solid-liquid separation vessels such as gravity, filtration, etc. are known. Gravity separation can be further classified according to the magnitude of the gravity force involved in the separation. For example, a 1G force separator is typically called a thickener/clarifier and cyclones and centrifuges are typical high G force separators. A typical thickener type of separator is characterized by a cylindrical upper section with a conical lower section to withdraw settled/separated solids from the process.

One class of separation vessels to which the instant feed delivery may be applied are gravity separation vessels. One sub-class of gravity separation vessels to which the instant feed delivery may be applied are froth separation units (FSUs) used to separate tailings and diluted bitumen from a bitumen froth feed. FSUs will now be explained further.

Among several processes for bitumen or heavy oil extraction, the Clark Hot Water Extraction (CHWE) process represents a well-developed commercial recovery technique. In the CHWE process, mined oil sands are mixed with hot water to create a slurry suitable for extraction. Caustic is added to adjust the slurry pH to a desired level and thereby enhance the efficiency of the separation of bitumen. Recent industry developments have shown the feasibility of operating at lower temperatures and without caustic addition in the slurrying process. Air is added to the slurry comprising bitumen, water, and sand, forming a bitumen-rich froth.

Regardless of the type of water-based oil sand extraction process employed, the extraction process will typically result in the production of a bitumen froth product stream comprising bitumen, water and fine solids (also referred to as mineral solids) and a tailings stream consisting of essentially coarse solids and some fine solids and water. A typical composition of bitumen froth is about 60 wt % bitumen, 30 wt % water and 10 wt % solids, with some variations to account for the extraction processing conditions. The water and solids in the froth are considered as contaminants and must be either essentially eliminated or reduced, for instance, to a level suitable for feed to an oil refinery or an upgrading facility. The contaminants rejection process is known as a froth treatment process and is achieved by diluting the bitumen froth with a sufficient quantity of an organic solvent. The two major commercial approaches to reject the froth contaminants are naphtha solvent based and paraffinic solvent based. The paraffinic solvent route will now be described further.

Generally, a paraffinic froth treatment (PFT), for instance a high temperature paraffinic froth treatment (HTPFT) process may be used to produce clean bitumen that meets or exceeds pipeline quality specifications. In this process, bitumen froth and a paraffinic solvent are mixed together to produce diluted bitumen (dilbit), precipitated asphaltene aggregates (aggregates) and a small quantity of free water and free mineral solids (minerals). The paraffinic solvent is chosen such that is promotes the precipitation of asphaltenes. The aggregates are complex porous structures of varying size, comprising precipitated asphaltenes, fine minerals, water and solvent. When introduced into a froth separation unit (FSU) by gravity settling, the negatively buoyant aggregates, coarse minerals and water settle, leaving a clarified supernatant comprising of diluted bitumen plus ppmw (parts per million weight) levels of water and mineral solids. This cleaned, diluted bitumen product is removed from the FSU as an overflow stream.

The solvent in the diluted bitumen product is usually recovered to obtain a clean bitumen product which needs to be blended either with condensate or synthetic crude oil to meet pipeline transportation viscosity and density specifications. In addition, the condensate or synthetic crude blended bitumen should meet the solids specification, for instance 300 ppmw as measured by the filterable solids test (ASTM-D4807). The 300 ppmw in the pipeline blended product is equivalent to 130 ppmw solids in the diluted bitumen exiting the FSU.

An example of a PFT process is described below, where an example of the paraffinic solvent used to dilute the froth before gravity separation is a mixture of iso-pentane and n-pentane. The paraffinic solvent is added to the froth to reduce the bitumen density and viscosity, and to promote flocculation of the emulsified water and suspended solids. The term “paraffinic solvent” (also known as aliphatic) as used herein means solvents comprising normal paraffins, isoparaffins, or a blend thereof, in an amount of greater than 50 wt %. Presence of other components such as olefins, aromatics or naphthenes counteract the function of the paraffinic solvent and hence should not be present more than 1 to 20 wt % combined and preferably, no more than 3 wt % is present. The paraffinic solvent may be a C₄ to C₂₀ paraffinic hydrocarbon solvent or any combination of iso and normal components thereof. In one embodiment, the paraffinic solvent comprises pentane, iso-pentane, or a combination thereof. In one embodiment, the paraffinic solvent comprises about 60 wt % pentane and about 40 wt % iso-pentane, with none or less than 20 wt % of the counteracting components referred above.

PFT differs from the other commercial bitumen separation process called naphthenic froth treatment (NFT) where the froth is diluted with naphtha to decrease the density and viscosity of the bitumen and to promote coalescence of emulsified water. In NFT, phase separation is achieved with gravity separation followed by centrifuging. The separation vessel of the PFT process is a gravity settler.

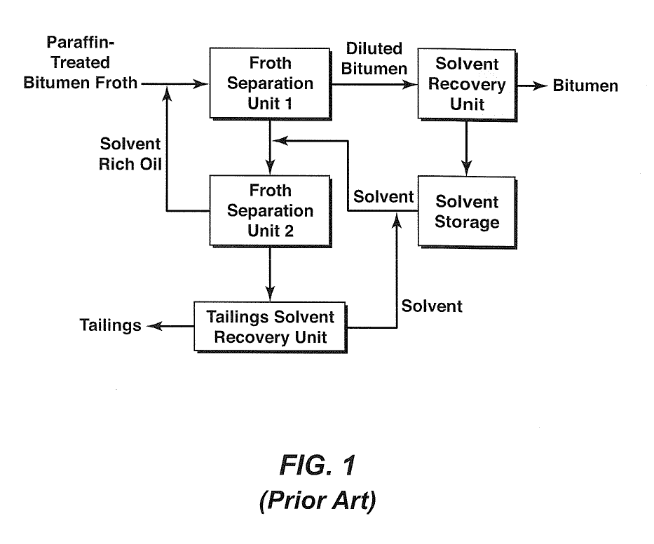

An example of a PFT process will now be described with reference to FIG. 1. A bitumen froth (having paraffinic solvent therein) is fed to an FSU where gravity separation is used to separate diluted bitumen from tailings. In FIG. 1, two FSUs (FSU-1 and FSU-2) are used. In FSU-1, the froth is mixed with a solvent-rich oil stream from FSU-2. The temperature of FSU-1 is maintained at about 60 to 80° C., or about 70° C. and the target solvent to bitumen ratio is about 1.4:1 to 2.2:1 by weight or about 1.6:1 by weight. The overflow from FSU-1 is the diluted bitumen product and the bottom stream from FSU-1 is the tailings comprising water, solids (inorganics), precipitated asphaltene aggregates, and some residual bitumen. The residual bitumen from this bottom stream is further extracted in FSU-2 by contacting it with fresh solvent, for example in a 25:1 to 30:1 by weight solvent to bitumen ratio at, for instance, 80 to 100° C., or about 90° C. The solvent-rich overflow from FSU-2 is mixed with the fresh froth feed as mentioned above. The bottom stream from FSU-2 is the tailings comprising solids, water, precipitated asphaltene aggregates, and residual solvent. Residual solvent is recovered prior to the disposal of the tailings in the tailings ponds. Such recovery is effected, for instance, using a tailings solvent recovery unit (TSRU), a series of TSRUs, or by another recovery method. Examples of operating pressures of FSU-1 and FSU-2 are respectively 550 kPag (kilopascal gauge) and 600 kPag. A solvent recovery unit (SRU) is used to recover solvent from the diluted bitumen exiting FSU-1. The foregoing is only an example of a PFT process.

Extensive tests at commercial process conditions were carried out in a relatively small pilot FSU using bitumen froth obtained from a commercial mine operation. This small pilot from hereon is referred to as “hot pilot”. These experiments showed that the precipitated asphaltene aggregates could be successfully removed from the diluted bitumen while also meeting the required specifications with regard to mineral solids carry-over concentrations in the product overflow stream. The term “carry-over” also synonymous with filterable solids in the product. The hot pilot FSU is 100 mm diameter by 1690 mm tall vessel, with a perimeter overflow weir located at the top of the vessel and a conical section located at the bottom of the vessel. The bitumen froth/solvent blend was introduced into the hot pilot FSU through a half inch diameter side-wall port located approximately at the mid-height of the vessel. Clarified diluted bitumen flowed over the upper weir while the asphaltene aggregates, water, mineral solids, and residual solvent flowed out the bottom of the vessel through a 60 degree cone. Analysis of the data obtained from the hot pilot FSU indicated that this high mineral separation efficiency was achieved because most of the mineral solids were either directly incorporated into the precipitated asphaltene aggregates or were trapped between precipitated asphaltene aggregates and carried to the underflow (“scavenged”). In these experiments, the mineral solids content in the overflow stream was found to increase from approximately 75 ppmw at an upward flux of 200 mm/min to approximately 78 ppmw at an upward flux of 250 mm/min. In these experiments, direct measurement of the actual size (diameter) of the precipitated asphaltene aggregates or the filterable mineral solids was not possible.

Scale up of the process from the 100 mm diameter hot pilot vessel with a volumetric flow rate of 0.118 m³/hr, to a more commercially viable volumetric flow rate of 1357 m³/hr for example, represents a 11,500 times increase in volumetric throughput. The construction of 11,500 100 mm diameter vessels is clearly impractical and therefore commercialization requires the scale-up to a larger vessel. A direct geometric scale-up of the hot pilot vessel to commercial scale would require a 9.6 m diameter by 162.24 m high vessel, which is quite impractical. A change in both vessel geometry and vessel size, is useful for commercial success. The increase in vessel diameter for 100 mm to 9.6 m, changes the fundamental flow characteristics from low Reynolds number laminar flow to turbulent flow, and the change in vessel shape significantly alters the flow distribution within the vessel. Reducing the height to width ratio of the vessel, and increasing the Reynolds number, are both detrimental to separation efficiency.

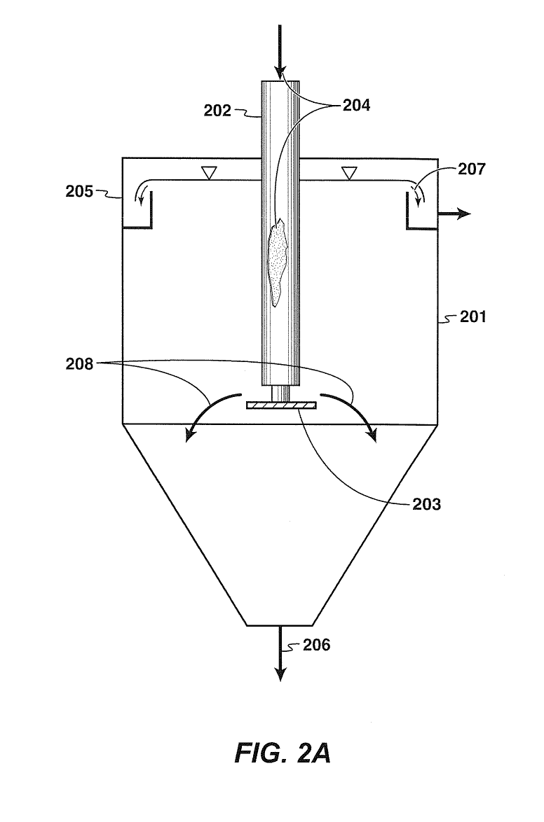

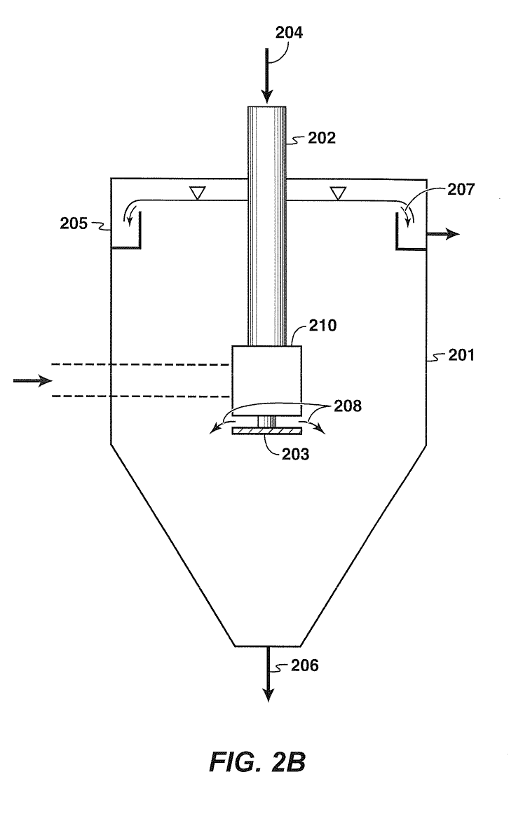

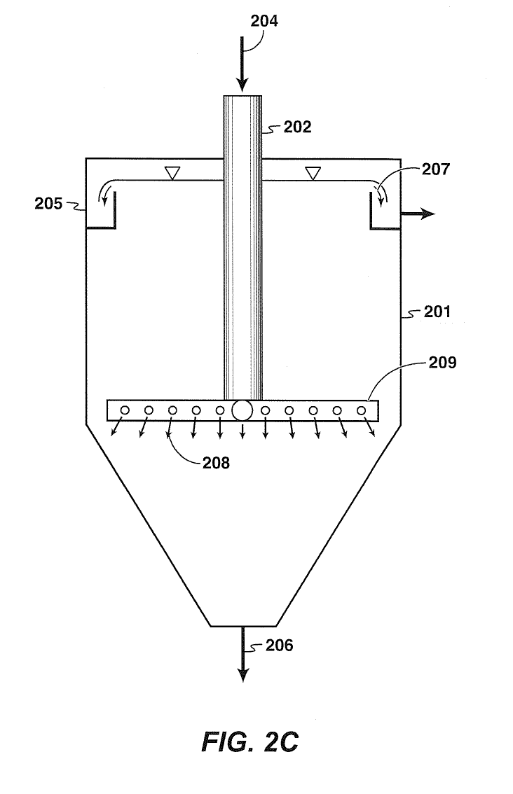

A PFT gravity settler, with a three different feed delivery systems is shown in FIG. 2A, FIG. 2B and FIG. 2C. In FIG. 2A, a slurry (204) is introduced to the settler vessel (201) by means of a vertical pipe (202) penetrating down through the top of the vessel. In order to re-direct the momentum of the incoming slurry and to distribute (208) the slurry over the cross-section of the vessel, a deflector plate (203) is attached below the exit of the vertical pipe. Precipitated asphaltene aggregates and large mineral solids settle downwards by gravity and are withdrawn from the bottom of the vessel (206). The clarified liquid product (207) overflows into a launder device (205) and reports to further downstream processing. The launder device (205) is a trough internal to the settler bounded by an overflow weir, across which clarified product is allowed to pass. In FIG. 2B, a slurry (204) is introduced into the settler vessel (201) by means of a vertical or horizontal pipe (202) discharging into a central feed-well (210) which reduces the momentum of the inflow and than distributed the slurry into the vessel through a single opening, or multiple openings, in the bottom of the feed-well. A deflector plate (203) may or may not be used in combination with a feed-well distributor to distribute (208) the feed. The launder device (205), withdrawal through the bottom of the vessel (206), and clarified liquid product (207) are also shown. In FIG. 2C, a slurry (204) is introduced into the settler vessel (201) by means of a vertical pipe (202) and sparger (209) comprising of a series of perforated pipes to insure good distribution (208). The launder device (205), withdrawal through the bottom of the vessel (206), and clarified liquid product (207) are also shown. In all three of these conventional designs the goals are to produce a uniform upward velocity distribution and to distribute the particles over the vessel cross-section.

One embodiment of the instant invention relates to the manner by which a solvent-treated/mixed bitumen froth is fed into an FSU for separation. One goal is to obtain good separation of solvent diluted bitumen from mineral solids and precipitated asphaltene aggregates at good or target throughput. Optimization of the feed delivery system may offer an opportunity to increase throughput and/or reduce capital investment with smaller or fewer settling vessels.

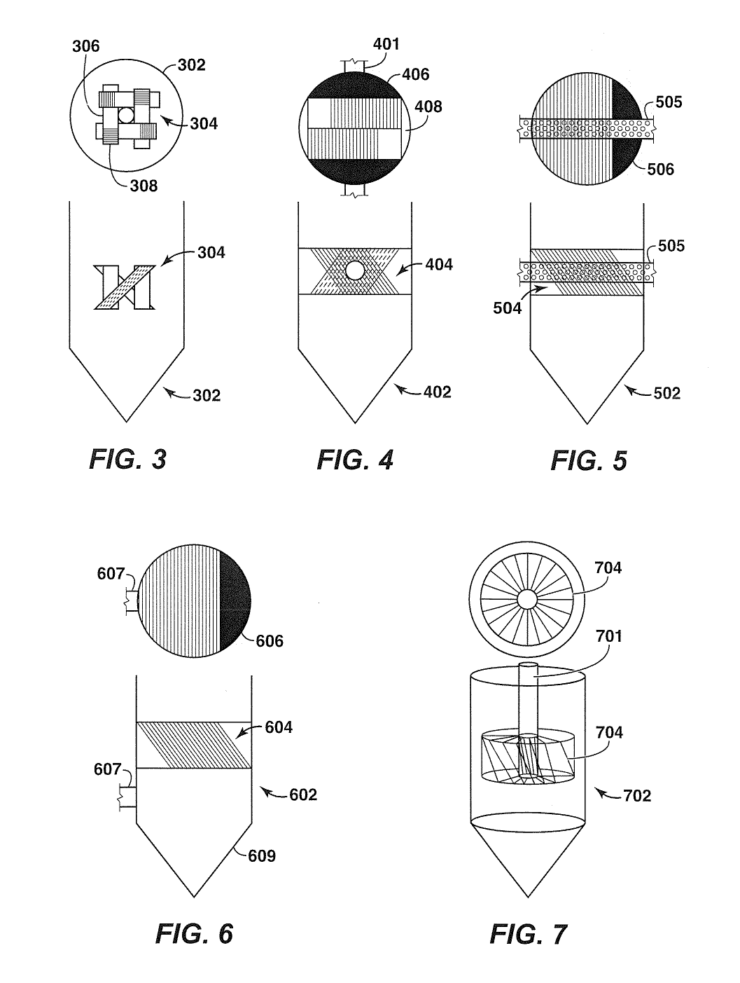

One embodiment provides a method of feed delivery to a separation vessel for the removal of particulates/flocculants from paraffinic solvent treated bitumen froth. Of course, throughout this specification, terms such as “removal” as relating to separation do not imply 100 percent removal, and the extent of removal desired will depend on the particular application and desired operating parameters. This feed delivery method can be applied to conventional settler vessels of the type commonly employed by the mineral processing and oil sands industries, among others. An example of a conventional FSU is shown in FIGS. 2A, 2B, and 2C having a round vessel with conical bottom section, and internal overflow launder. Whereas a conventional feed delivery system may consist of a vertical pipe with a deflector plate (FIG. 2A), feed-well (FIG. 2B) or sparger (FIG. 2C), this embodiment comprises the use of an inlet feed conditioner comprising of a series of parallel plates which may be inclined as illustrated in FIG. 3. Based on physical modeling results, this arrangement is shown to offer superior separation performance when compared with conventional vertical pipe/deflector plate designs. Physical modeling is a proven scale up technique designed to simulate the process and materials involved in the commercial process using scale models and surrogate materials of the pilot and commercial units. Such physical model testing is also referred to as cold flow testing because it is often performed at or near room temperature condition. Data obtained from extensive physical modeling simulations of the actual PFT process show that the use of parallel plate inlet feed conditioning consistently outperforms conventional distributors such as a vertical pipe and deflector design as well as a side-inlet feed configuration described in Canadian Patent Application No. 2,672,004, filed Jul. 14, 2009.

While the designs, according to embodiments of the present invention, may include plates at an inclined angle, they are not conventional Tilted Plate Separators for at least three reasons. First, the operating principle is fundamentally different, indeed, it will be shown below that superior performance is obtained even when the plates are vertical. Second, the plates are limited to the inlet fixture and are not distributed throughout the vessel. Third, in the present designs, the flow rates can be significantly higher than is normally prescribed for conventional Tilted Plate Separators.

The operating principle behind a standard Tilted Plate Separator system is as follows. The introduction of the tilted surface reduces the physical settling distance that a falling particle must travel before reaching a solids surface. Once particles reach the solid surface, they slide down the plate to the lower section of the vessel. For a given vessel size, the addition of multiple parallel plates dramatically increases the effective setting area. In a conventional Tilted Plate Separator system, the plates require sufficient slope to prevent solids accumulation from occurring and the channel Reynolds number is typically quite low to preserve laminar, or near laminar, conditions. Furthermore, the tilted plates occupy most of the internal area of the vessel. In contrast to a Tilted Plate Separators, the present system occupies a relatively small fraction of the total vessel volume and can operate at a much higher Reynolds number. While the included surfaces do reduce the settling distance for the larger particles, the more important feature of the design is the propensity for fine particles to become, and remain, entrained within the coarse particles. Experimental data showed that this elevated degree of fines separation can be achieved at channel Reynolds numbers which are significantly higher than is normally recommended for a conventional Tilted Plate Separator operation. For example, a channel Reynolds number for a conventional Tilted Plate Separator operation may be less than 200, or for the specific example of a 100 mm gap in a commercial geometry, less than about 130 to prevent turbulent mixing. Without intending to be bound by theory, it may be speculated that this geometry enhances the occurrence of fine particle scavenging, a phenomena observed and discussed by Schubert, H. (2004) On the origin of “anomalous” shapes of the separation curve in hydrocyclone separation of fine particles. Particulate Sci. & Tech. 22 pp. 219-234 and Hoffman & Stein, (2002) Gas Cyclones and Swirl Tubes: Principles, Design, and Operation. Springer-Verlag.

Examples of conventional Tilted Plate Separators are described in U.S. Pat. No. 3,886,064 (Kosonen), U.S. Pat. No. 4,218,325 (McMullin), U.S. Pat. No. 4,351,733 (Salzer), U.S. Pat. No. 4,889,624 (Soriente), U.S. Pat. No. 4,957,628 (Schulz), U.S. Pat. No. 5,049,278 (Galper), and U.S. Pat. No. 5,378,378 (Meurer), and U.S. Patent Publication No. 2010/0089800 (MacDonald). The plates in these designs occupy a large fraction of the vessel interior.

FIG. 3 illustrates one embodiment. In this case, a feed stream enters the top of the vessel (302) through a vertical pipe (not shown) which extends down to the centrally located parallel plate assembly (304). The feed is then directed into the sides of the four sloped chambers (306) which are open at the bottom and top, each containing a series of parallel plates (308) making up an inlet feed conditioner. The coarse particles settle quickly toward the plate surfaces, densifying, and trapping fine particles in the process. The elevation of the bottoms of the four chambers is selected to discharge into the lower portion of the vessel which contains an increased concentration of coarse particles, to ensure that the fines remain trapped within the coarse particles. Clarified liquid exists from the top of the four chambers. Many other possible designs can be envisioned including side wall entry into the chambers and installation in a vessel of another shape, such as rectangular or square.

Preferably, if the parallel plates are inclined, there should be a continuous flow past the surfaces to reduce the risk of fouling. Additionally, the surfaces of the parallel plates may be made with, or coated with, an anti-fouling composition. To minimize fouling of the parallel plates, the plates may be placed in the water continuous region of the vessel. Preferably, the minimum gap between the parallel plates at commercial scale may be greater than 100 mm. The plates can range from simple parallel plates to more complex vein assemblies designed to create quiescent regions with enhanced settling characteristics, as described below.

An example of an FSU using a conventional centrally located feed distributor is a 9.6 m diameter cylindrical vessel, having an internal perimeter overflow weir and launder, a bottom conical section and the centrally located feed distributor. A bitumen froth plus solvent feed injection rate could be 1357 m³/hr with a flow split of approximately 80% volume overflow and 20% volume underflow, giving a nominal upward flux of about 250 mm/min. The target maximum solids specification may be, for instance, 200 ppmw or 130 ppmw. A solids separation efficiency of over 99.8% may be desired to meet a 130 ppmw solids specification, based on the composition of certain oil sands leases located in northern Alberta, Canada. These values are merely provided by way of example.

During cold flow testing described below, a physical model and analogue materials to represent the precipitated asphaltene aggregates, mineral solids, and diluted bitumen, and water, were used to evaluate and optimize feed distribution systems. Experiments were performed in a 1:1 scale model of the hot pilot FSU using spherical glass beads to represent various possible distributions of precipitated asphaltene aggregates and mineral solids in the hot pilot FSU. By combining the mineral solids carry-over data from the hot pilot FSU overflow stream with the grade carry-over curves determined in the cold flow pilot FSU and data from batch hindered settling experiments, it was possible to develop a very good estimate of the size distribution of mineral solids and asphaltene aggregates. On the basis of this work, it was concluded that the solid particles entering the hot pilot FSU consisted of a high mass fraction of relatively large precipitated asphaltene aggregates and a low mass fraction of free mineral solids. The size distribution of the aggregates was approximately Gaussian (in part based on an optical measurement technique), with a d50 of about 600 microns determined from lab model and pilot testing which suggested an average terminal velocity of about 2700 mm/min, and a hindered settling velocity of about 1350 mm/min (at a solids volume fraction of 12% vol and a Richardson Zaki coefficient of 5.4). Although the exact size distribution of free mineral solids was not determined, it was estimated that about 2% of the total mineral solids entering the separator were free mineral solids, with terminal velocities between 0 and 1350 mm/min. It was also estimated that approximately 60% of these free mineral solids had terminal velocities below 200 mm/min, and the remaining 40% had terminal velocities relatively uniformly distributed between 200 mm/min and 1350 mm/min. The overall particle size distribution was therefore bi-modal in shape, with a relatively uniform and low concentration of mineral solids between the lower and upper peaks.

### Parallel Plate Inlet Conditioning Design

In one embodiment, it is desirable to have a feed delivery design that conditions the flow to induce solids segregation and fines scavenging prior to discharging the feed into the vessel. One option is to introduce the flow into a series of parallel plates which are located within an enclosure located either within the vessel or adjacent to the vessel. The parallel plates modify the flow field by reducing the local Reynolds number and by providing an environment which is conducive to the settling of coarse solids and a high degree of fine particle scavenging. Various embodiments are illustrated in FIGS. 4 to 10, described individually below.

### Parallel Plate Packs

FIG. 4 comprises two rectangular parallel plate assemblies (404) installed adjacent to one another in the central region of the vessel (402). Feed is introduced into two plenums (406), one located on either side of the plate assemblies adjacent to the vessel wall. The flow leaves the conditioning plenum and enters the channels through a horizontal slot (or series of holes) located in the side of the plate assembly. The plate assembly flow split does not have to match the vessel flow split because an alternative flow path is available through the two open regions (408) located 90 degrees opposed to the two inlet plenums.

### Parallel Plate Packs

The design shown in FIG. 5 is the same as the design of FIG. 4 except that the parallel plate assembly (504) fills the entire vessel (502) cross-section, eliminating the alternative flow path. In this case, the slurry is delivered to the channels through a perforated pipe (505) extending across the plates. A central plenum (506), extending across the full width of the vessel, could also be employed in this case.

### Parallel Plate Packs

The design shown in FIG. 6 is the same as the design of FIG. 5 except that slurry is delivered to the lower chamber (609). In this design, the slurry is delivered into the lower chamber (609) through a side-wall port (607). The vessel (602), plenum (606), and parallel plate assembly (606) are also shown.

### Centrally Located Feed Turbine

The design of FIG. 7 is similar to the design of FIG. 4 except that the plates (704) are arranged in an axial configuration with the feed entering from a central feed pipe (701). The plate gap increases with radial position and therefore this design may not produce optimum performance. This distributor is attractive because it could be placed at any elevation in the vessel (702) and the central feed delivery into the distributor is both simple and compact.

### Upward Pointing Nested Cones

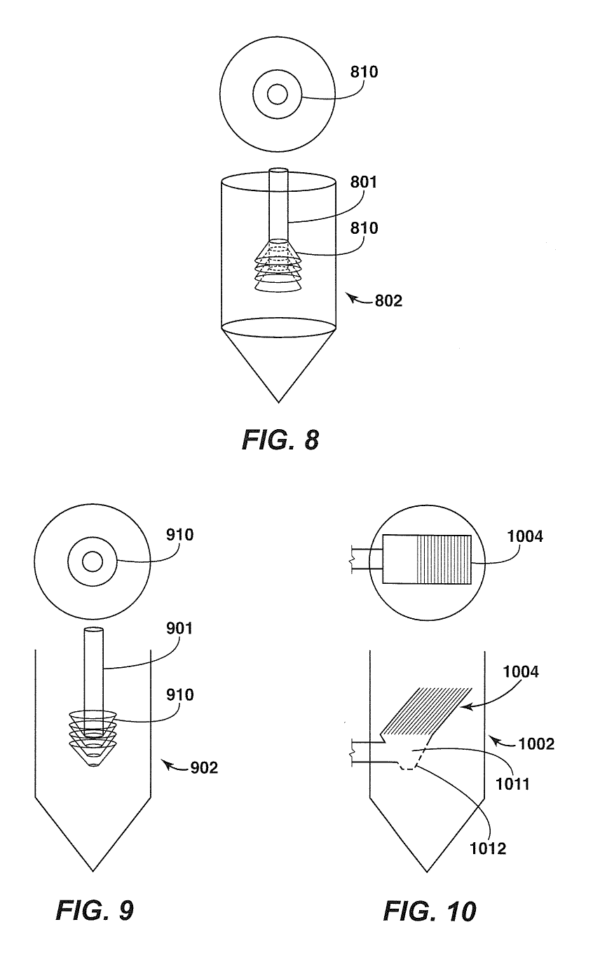

The design of FIG. 8 comprises a central downward feed pipe (801) with a series of nested conical surfaces (810) which form the inclined channels. Unlike the design of FIG. 7 where the feed is introduced at a midpoint along the length of the channels, this design introduces the feed at the upper end of the channels adjacent to the center delivery pipe (801). In this design, the flow is driven outward in all of the channels, and therefore the densified and clarified layers flow co-currently rather than counter-currently. One of the challenges with this design is the risk of re-entraining separated solids (including fines) at the discharge end of the channels because the clarified liquid layers must cross-over the densified layers. The vessel (802) is also shown.

### Downward Pointing Nested Cones

The design of FIG. 9 is very similar to the design of FIG. 8 except that the cone orientation is inverted. The operating principle in this case is that the upper region of the cones (910) are flooded at a concentration approximately equal to the feed concentration. As the slurry moves downward and densifies, the cross-sectional area decreases. In the optimum design, the density of the discharge from the bottom of the cones would be less than the vessel underflow density but significantly higher than the inlet density. The center delivery pipe (901) and the vessel (902) are also shown.

### Sump Box

In FIG. 10, the feed is delivered into a sump (or well) (1011) having perforations (1012) on the bottom and sides to permit the discharge of densified slurry. The rising liquid phase, moderately or lightly loaded with particles, rises through a series of inclined channels of the parallel plate assemblies (1004) to aid in the clarification process, with the densified solids being returned back in to the sump (1011). The vessel (1002) is also shown.

### Reducing the End Plate Re-Entrainment (Cross-Over)

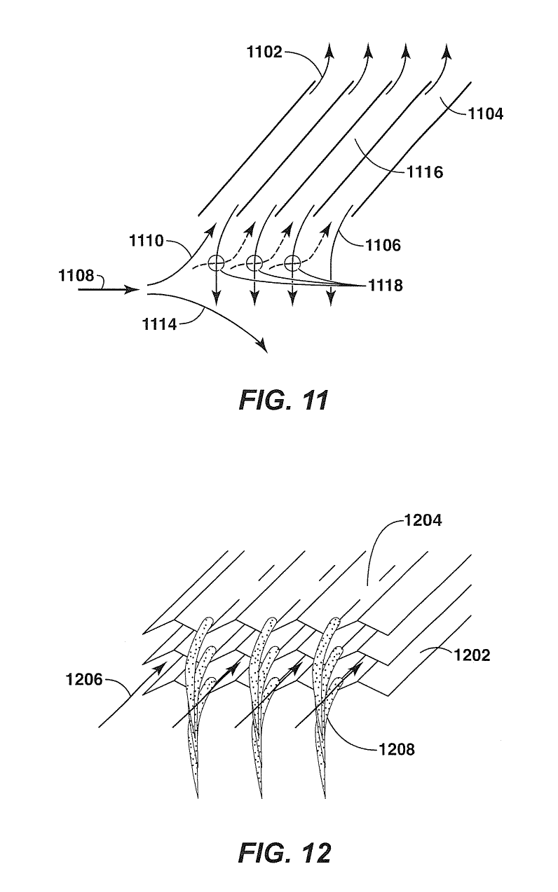

One potential challenge associated with any of the plate configurations described is that of cross-over. This phenomena is illustrated in FIG. 11, which shows clarified stream components (1102) rising from the top of the individual channels (1104), along with streams (sheets) of rejected solids (1106) falling from the bottom of the channels. In the case where feed (1108) is introduced from the underside of the plates, it is evident that overflow fluid (1110) must cross-over (1118) streams of rejected solids (1106) to enter various channels, introducing the risk of fines re-entrainment as the streams cross. This illustration typifies the cross-over problem, which most closely applies where feed is introduced solely at one end of the channels. A similar problem may be encountered even in a design where the feed is introduced in a middle portion of the channels, if the initial volumetric split through the individual channels is not perfectly matched to the overall vessel flow split, and thus some fluid redistribution may need to occur across channels. The underflow split (1114) and the clarification zone (1116) are also shown.

One design modification to mitigate this problem is shown in FIG. 12. This shows the flat plates replaced with corrugated sheets (1202), the intent of which is to convert planar sheets of solids (which are interspersed between planar sheets of clarified liquid) into consolidated streams which are better able to resist entrainment when they cross through the clarified layers. The corrugated channels (1204), overflow split (1206) and rejected solids (1208) are also shown.

### Methods of Controlling Flow Split

Flow split through a design where the feed is delivered into a middle portion of the plates (such as in FIGS. 3, 4, 7, 8 and 9 configuration is not explicitly set by the vessel overflow and underflow rates, but depends on the hydrodynamic conditions within the plate assembly. If the pressure drop through the plates is high for example, then the overflow and underflow rates would be approximately equal, which could result in poorer separation efficiency compared to the case where the assembly flow split more closely matches the vessel flow split. For example, the cross-over problem just discussed becomes more problematic as the difference between the plate assembly flow split and the vessel flow split increases.

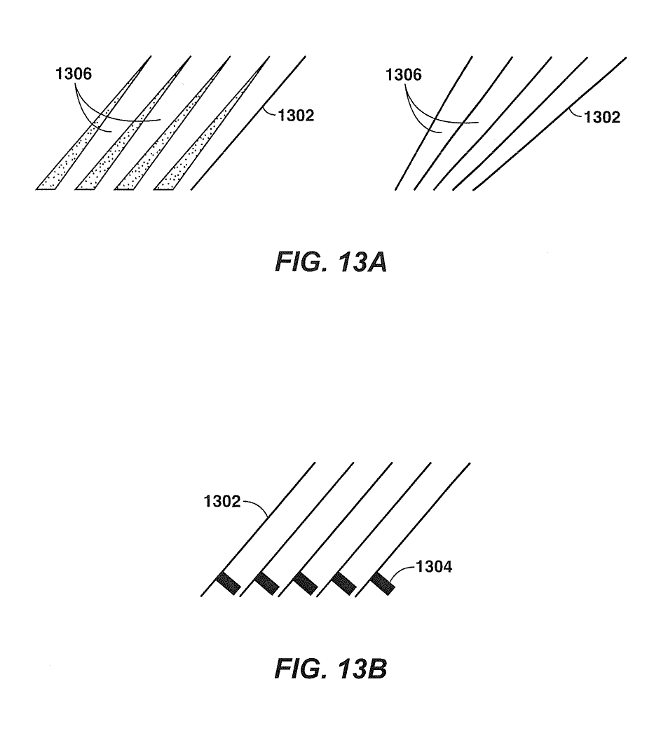

Two possible options were identified to mitigate this situation as illustrated in FIGS. 13A and 13B, where the plates (1302) are shown. Either the plate spacing (1306) could be reduced toward the lower end of the assembly (FIG. 13A), or a slip (1304) (extending downward from the upper plate) could be added to each channel to restrict the flow (FIG. 13B). The latter method was employed in one of the geometries tested in the 1:8 commercial FSU model.

### Experimental Results

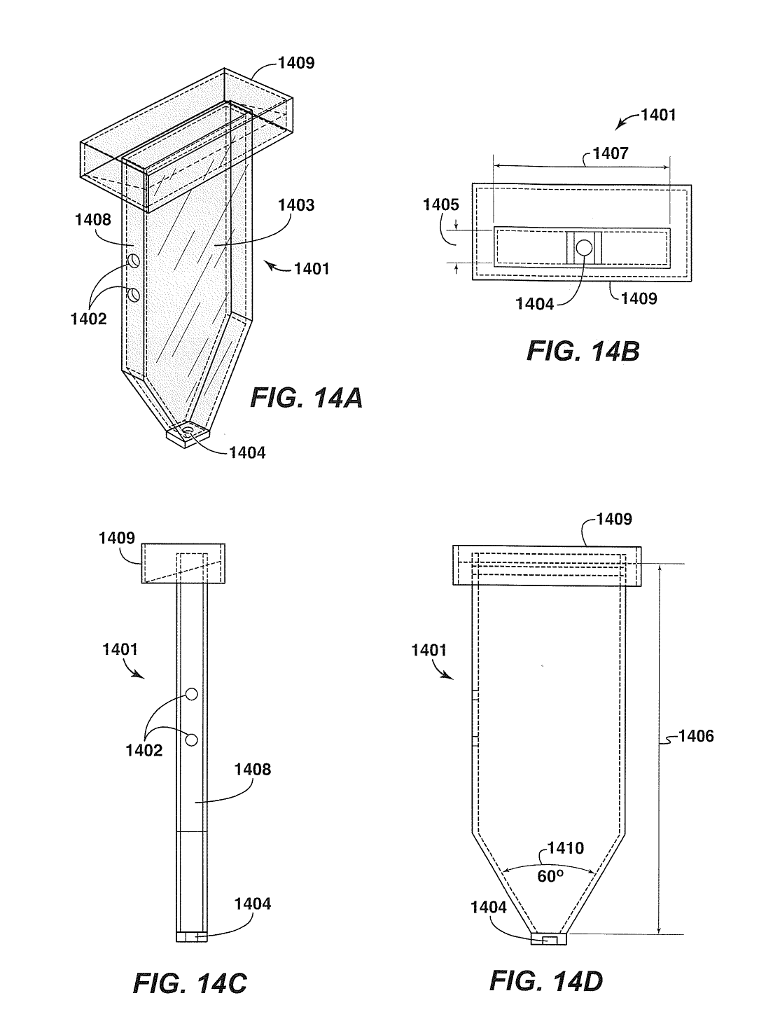

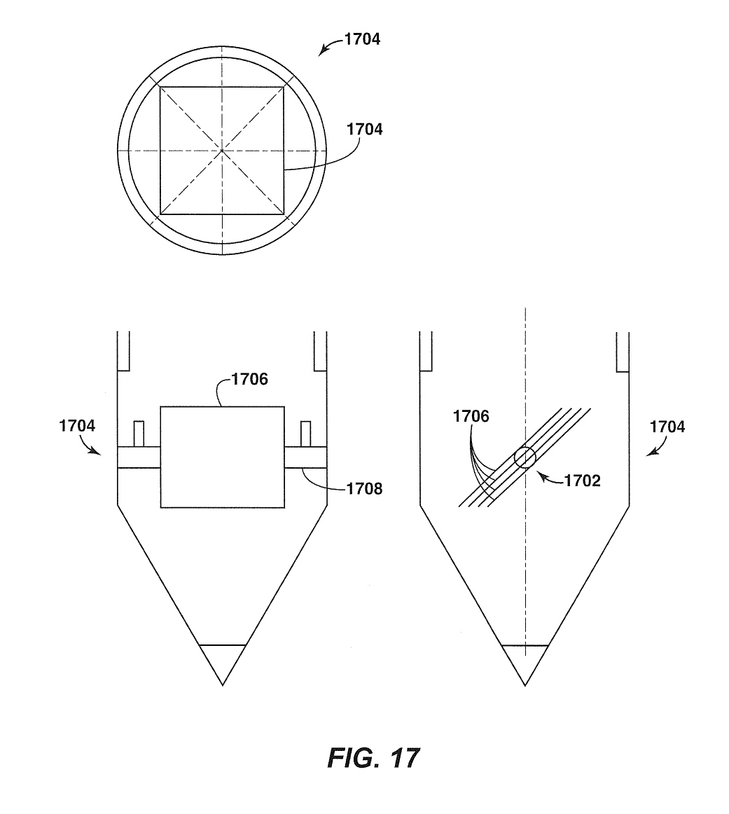

Laboratory experiments were performed to gain insight into the potential benefits associated with parallel plate inlet flow conditioners. Two types of experiments were performed. In the first series of experiments, the performance properties of a stand-alone parallel plate assembly was evaluated, while in the second set of experiments a parallel plate assembly was installed within a physical model of a commercial FSU. FIG. 14 shows the stand-alone configuration tested in the laboratory, FIGS. 17 and 19 show the configurations tested in a FSU physical model.

### Parallel Plate Inlet Flow Conditioner Performance—Stand Alone Conditioner and Low Reynolds Numbers

The simple apparatus shown in FIGS. 14A-14D allowed the basic performance of the multi-plate inlet conditioning section to be evaluated independently of the surrounding vessel. Using this apparatus (1401), it was possible to evaluate one, two, or four channels. The channel (1403) width (1407) was 303 mm, the channel length (1406) was 609 mm and the total channel gap was 50 mm (1405). Additional plates could be added to create two 25 mm channels or four 12.5 mm channels. The width of the channels contracted to a single bottom port (1404) where the interior angle (1410) was 60 degrees. The feed could be introduced into the channel through either of two ports (1402) located in the middle of the gap on the side-wall (1408) 317 mm and 415 mm from the overflow weir (1409). Dilution water was added to the underflow just after it exited the bottom of the vessel and the overflow stream was discharged over a simple weir into a launder which then gravity-drained back into the preparation tank. The apparatus was mounted on a support frame which allowed the slope of the channel to be varied from vertical (0 degrees) to horizontal (90 degrees).

Tests were performed to determine the performance of the stand-alone multi-plate flow conditioner as a function of Re (Channel Reynolds number), L/D_{gap}, φ (solids volume fraction), θ (slope), and Qₙ/Qᵢₙ (flow split). In this case Channel Reynolds number is defined as:

$$Re = \frac{ρ {UD}_{gap}}{μ}$$

where:
ρ=fluid density
U=superficial channel velocity
D_{gap}=gap distance
μ=fluid viscosity

The following ranges were evaluated 84<Re<541, 9.4<L/D_{gap}<37.6 , 0.01<φ<0.12, 0°<θ<45° and 0.5<Qₒ/Qᵢₙ<0.8, where L is the length of the inclined plate, D_{gap} is the channel gap, φ is the solids volume fraction, θ is the slope of the channels (referenced to vertical), Qₒ is the overflow volumetric flow rate, and Qᵢₙ is the inlet volumetric flow rate.

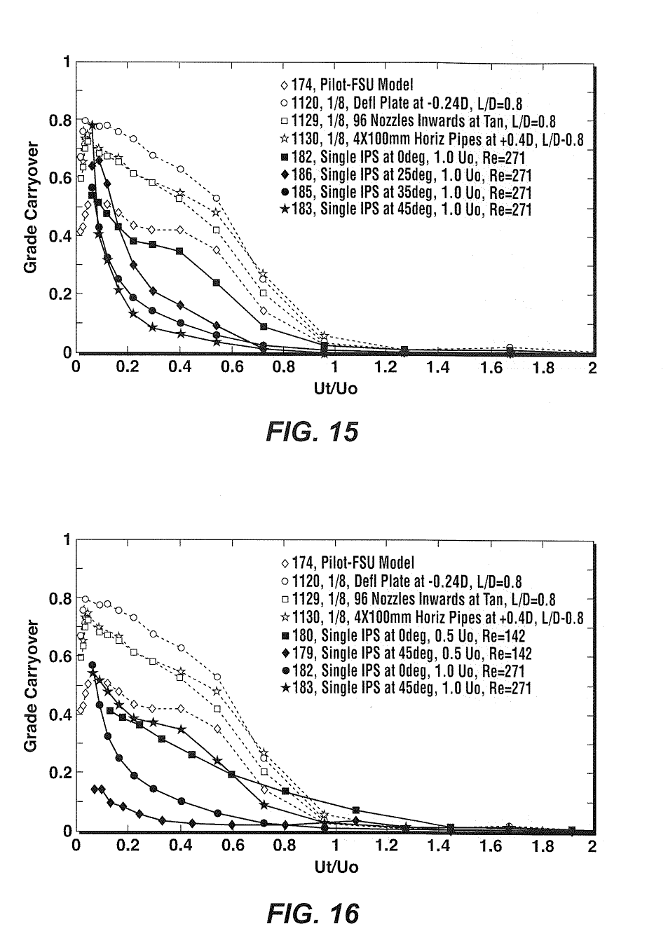

Normalized grade carry-over curves obtained with a single 50 mm channel are shown in FIG. 15. These normalized grade carry-over curves show the fraction of inflowing particles which report to the overflow as a function of there terminal velocity range, where the particle terminal velocity has been normalized by the upward superficial velocity in the cylindrical section of the vessel. In these tests, the flow split (Qₒ/Qᵢₙ) was 0.8, the solids loading was 12% (φ=0.12) and the upward superficial velocity was 320 mm/min (selected to simulate 525 mm/min in a commercial system) giving a channel Reynolds number of 271. These results show that the vertical channel provided approximately 20% better performance compared to the 100 mm diameter pilot geometry, and that inclining the channel off vertical improved the performance. Optimum performance was observed at a slope of about 35 degrees off vertical, for which the reduction in carry-over was approximately 90% relative to the pilot FSU geometry. It is interesting and important to note that the vertical orientation was superior to the normalized performance obtained in the 100 mm diameter pilot geometry, and significantly better than the performance obtained using more conventional feed delivery systems in the commercial FSU model. Without intending to be bound by theory, it is believed that this is because the plates provide an environment conducive to fines scavenging.

Decreasing the flux by 50% to achieve a Channel Reynolds number of 142 was found to further improve the normalized grade efficiency for the sloped channel, but did not have any significant impact on the performance for the vertical orientation as shown in FIG. 16. The single channel sloped at 35 degrees and operating at a Reynolds number of 142 was able to capture more than 90% of the fines over most of the measureable size range.

### Parallel Plate Inlet Conditioner Performance—Moderate Reynolds Numbers

Practical considerations in commercial systems related to plugging or fouling often limit the minimum acceptable clearance that can be used in vessel internals. These restrictions can make it challenging to achieve Channel Reynolds numbers on the order of 100, with more typical values being in the range of 1000 to 2000 for plate spacings in the range of 100 mm to 200 mm. The second consideration in a commercial configuration is the fact that the discharge from the top and bottom of the parallel plate inlet flow conditioner discharges directly into the vessel, which creates the potential for either increased or decreased separation efficiency due to the added influence of circulation and mixing in the vessel. A series of experiments were performed to determine the benefit of a parallel plate inlet flow conditioner when operating at higher Reynolds numbers and when installed in a configuration which more closely resembles a typical commercial installation, where the discharge from the top and bottom of the parallel plate inlet flow conditioner would discharge clarified fluid upward in the upper cylindrical section of the vessel and densified slurry downward into the steep cone section of the vessel. The basic experimental arrangement is shown in FIG. 17, where the flow conditioning elements (1702) were installed in the central region of the vessel (1704), and slurry was delivered into the side of the channels (1706) through two pipes (1708) located on either side of the series of parallel plates. In order to properly simulate the correct commercial Channel Reynolds numbers, the parallel plate inlet flow conditioner (1702) was not scaled relative to the commercial vessel in the same proportion to the vessel. While the vessel was about 1:8 scale of a typical commercial vessel the inlet flow conditioner was closer to 1:1 scale.

### Parallel Plate Inlet Conditioner Performance—High Reynolds Numbers

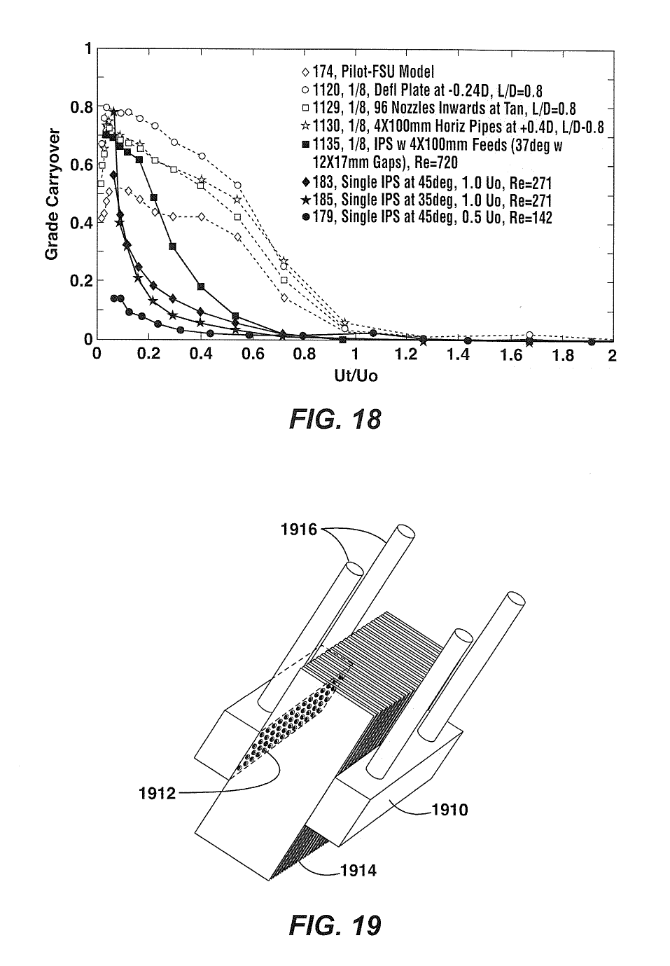

The data obtained in the twelve channel inlet flow conditioner oriented at 37 degree (FIG. 17) is shown in FIG. 18 in combination with the low Reynolds number data obtained in the stand-alone apparatus and with the more conventional configurations installed in the same model. These data indicate that the parallel plate inlet flow conditioner operating at a Channel Reynolds number of 720 provides a significant benefit compared to the 100 mm pilot geometry and the other conventional inlet distributors, but poorer performance compared to the stand-alone inclined channel operating at Re=271 and Re=142.

In order to determine the upper Reynolds number performance limit, an additional plate assembly was tested in the laboratory. This configuration comprised 55 mm channels with a plate width and length of 830 mm and 700 mm respectively. When operating with three channels the Channel Reynolds number was 2860 and when operating with four channels the Channel Reynolds number was 2150. The inlet configuration for this 55 mm channel assembly was slightly different compared to the twelve 17 mm channel assembly as shown in FIG. 19. A small inlet plenum (1910) was mounted on either side of the parallel plates to more uniformly introduce the feed into the channels through feed arms (1916). The perforated plate (1912) and inclined plates (1914) are also shown.

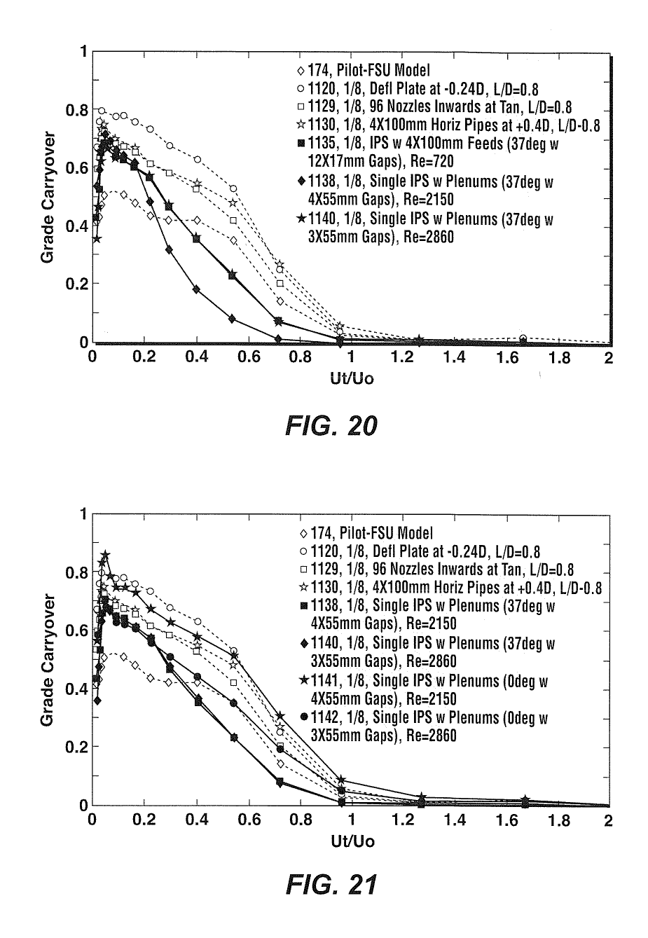

FIG. 20 shows that the higher Re case (55 mm channel gap) with a lower channel L/D did not perform as well as the lower Re case (17 mm channel gap), but that it did out perform the 100 mm pilot geometry for Ut/Uo> above 0.25 and the other conventional inlet distributors. When the three and four channel parallel plate inlet flow conditioner was oriented vertically there was relatively little performance benefit compared to the other conventional inlet distributors as shown in FIG. 21.

These results have demonstrated that the introduction of a parallel plate inlet flow conditioner operating at a Reynolds number of less that 2000 can provide improved separation efficiency as a result of enhanced fines scavenging. The benefit for the case of parallel plates inclined at about 35 degrees ranges from approximately 25% to 80% as the Channel Reynolds number is reduced from about 2000 to about 200. The benefit for the case of parallel plates installed vertically ranges from approximately 10% to 50% as the Channel Reynolds number is reduced from about 1000 to about 200.

What is claimed is:

1. A method of delivering a feed, the feed comprising a liquid component and a solid component into a separation vessel for separating the liquid component from the solid component, the method comprising:
delivering the feed into the vessel through one or more inlets in the vessel into sides of a series of plates that form a series of channels of an inlet feed conditioner, wherein the feed is delivered with a Channel Reynolds number of less than 3000, to encourage smaller solid particles of the solid component to be incorporated into, or trapped within or under, or entrained down by, larger solid particles of the solid component, or aggregates of the larger solid particles, and to be carried to an underflow.

2. The method of claim 1, wherein the parallel plates occupy less than 20% of a cross-sectional area of the vessel.

3. The method of claim 1, wherein the parallel plates occupy less than 10% of a cross-sectional area of the vessel.

4. The method of claim 1, wherein the Channel Reynolds number is greater than 200.

5. The method of claim 1, wherein the Channel Reynolds number is less than 1000.

6. The method of claim 1, wherein the plates are inclined from vertical by an angle of 5 to 85 degrees.

7. The method of claim 1, wherein the plates are within 5 degrees of vertical.

8. The method of claim 1, wherein the plates are vertical.

9. The method of claim 1, wherein the plates have a length to gap ratio of at least 15.

10. The method of claim 1, wherein the plates are parallel within an angle of 10% with one another.

11. The method of claim 1, wherein the parallel plates are separated from one another by between 100 mm and 200 mm.

12. The method of claim 1, wherein the feed is a solvent-treated bitumen froth.

13. The method of claim 1, wherein the solid component has a bi-modal size distribution.

14. The method of claim 1, wherein the solid component comprises precipitated asphaltene aggregates and mineral solids.

15. The method of claim 1, wherein the feed is delivered at a rate sufficient to generate a superficial vessel flux of 200 mm/min to 700 mm/min.

16. The method of claim 14, wherein more than 50 mass % of the mineral solids have a terminal velocity less than an upward superficial velocity of the liquid component in the vessel.

17. The method of claim 1, wherein the plates are flat.

18. The method of claim 1, wherein the plates are disposed with a plate spacing that narrows from a top of the inlet feed conditioner to a bottom of the inlet flow conditioner.

19. The method of claim 1, wherein the plates are disposed with a plate spacing that is more narrow at a bottom of the inlet feed conditioner than at a top of the inlet flow conditioner.

20. A feed inlet conditioner system for use with a froth separation unit for feeding and conditioning solvent-treated bitumen froth comprising bitumen, water, precipitated asphaltene aggregates, and mineral solids, the system comprising:
a feed inlet conditioner comprising a series of parallel plates forming a series of channels therebetween for encouraging the mineral solids of a solid component of the froth to be incorporated into, or trapped within or under, or entrained down by the precipitated asphaltene aggregates of the solid component and to be carried out to an underflow; and
at least one inlet for delivering the feed to sides of the parallel plates.

21. The system of claim 20, wherein the side-inlet Richardson number is equal to or greater than 2.0 but not more than 13.2.
